(19) United States
(12) Patent Application Publication
(10) Pub. No.: US 2013/0008538 A1
(43) Pub. Date: Jan. 10, 2013

(54) VALVE FOR ALTERNATELY FILLING TWO WORKING CHAMBERS OF A PISTON-CYLINDER SYSTEM OF A PUMP

(75) Inventor: Thomas Schütze, Schonungen (DE)

(73) Assignee: PROMERA GmbH & Co. KG, Sennfeld (DE)

(21) Appl. No.: 13/636,763

(22) PCT Filed: Mar. 18, 2011
(86) PCT No.: PCT/EP2011/001359

§ 371 Date: Sep. 24, 2012

(30) Foreign Application Priority Data
Mar. 26, 2010 (DE) 10 2010 013 107.5

(51) Int. Cl. F16K 11/00

(52) U.S. Cl. 137/625

(57) ABSTRACT

The invention relates to a valve for alternately filling two working chambers (A, B) of a piston-cylinder system (1, 2, 3) of a pump with a fluid, wherein the valve has two valve pump outlets (P_{A}, P_{B}), for connection to the working chambers (A, B) of the pump and has a valve control element (64) that is displaceably arranged in a space of a valve housing (60, 61, 76, 77) and can be movably driven backwards and forwards between two end positions by a fluid, wherein the valve control element (64) has control ducts (67, 82, 83, 84) that co-operate with housing ducts (51, 71, 72, 80, 81) arranged in the valve housing (60) wherein the first valve pump outlet (P_{A}) is connected to the housing ducts (71, 80) and the second valve pump outlet (P_{B}) is connected to the housing ducts (72, 81), wherein in a central region between the two end positions the valve pump outlets (P_{A}, P_{B}) are connected to one another via control ducts (82, 83, 84) of the valve control element (64).

The present invention relates to a valve for alternately filling two working chambers of a piston-cylinder system of a pump with a fluid, wherein the valve has two valve pump outlets for connection to the working chambers of the pump and has a valve control element that is displaceably arranged in a space of a valve housing and can be moved backwards and forwards in a fluid-driven manner between two end positions, wherein the valve control element has control ducts that co-operate with housing ducts arranged in the valve housing, wherein the first valve pump outlet is connected to the housing ducts and the second valve pump outlet is connected to the housing ducts.

Generic valves of the above type are required for example for filling the working chambers of membrane pumps and also piston pumps. With membrane pumps the membrane delimits a conveying chamber, in which a feed line and an outflow line terminate. As a rule non-return valves are arranged in the feed lines and outflow lines so that, due to the backwards and forwards movement of the membrane, the conveying medium is first of all suctioned through the feed line into the conveying chamber and can then be expelled from the conveying chamber through the outflow line.

So as to ensure a continuous conveyance, generally two membrane pumps are connected in parallel, wherein one of the pumps suctions the conveying medium and the other expels the conveying medium from its conveying chamber at the same time.

Double membrane pumps are also known, in which the membranes, which are generally formed as disc membranes, can be adjusted by means of a common piston-cylinder system or by means of an electric drive. In chambers in which explosive gases can be formed, no electric pumps are allowed to operate or stringent requirements have to be observed to protect against explosions. In this case pneumatic pumps are as a rule used, in which a piston, which is mechanically connected to the membranes, is moved backwards and forwards in a cylinder by means of compressed air. The compressed air is in this connection switched by means of a main valve in such a way that the two working chambers are alternately filled with compressed air. Such a pump is known from U.S. Pat. No. 4,818,191. The spaces separated from the conveying chamber by the membranes are connected to the surroundings by means of ducts, so that in the event of a leakage the conveying medium can escape from the pump and the movement of the membranes is not affected. A disadvantage with this pump is that the membranes are subjected to a high differential pressure loading on account of the high pressure in the conveying chamber and the ambient pressure prevailing behind the membrane, which leads to rapid wear of the membranes.

A further developed pneumatically driven double membrane pump is known from WO2009/024619. In this pump the compressed air driving the piston is simultaneously led into the space behind the membrane. At the same time the membrane is supported by a disc, which however only at the dead centre completely abuts the membrane in a supporting manner. A disadvantage of this pump is that if there is a defect in the membrane the conveying medium can reach the pneumatic system and cause the valves and therefore the whole pump to fail. Following this the pump can be restored to operation only with much effort and expenditure, if at all.

A double-chamber membrane pump without driven pistons is known from DE 32 06 242. A main valve is disclosed for this pump, in which a piston that moves backwards and forwards between two end positions in a cylinder is used as valve control element, wherein the piston comprises surrounding grooves and axial bores as control ducts. A disadvantage with this pump are the large chambers that have to be filled with compressed air after the dead centre is reached, in order that the membrane can be moved in the other direction. A very large amount of compressed air is required for this purpose, which increases the maintenance costs of the pump. A similarly constructed pump having the same disadvantages is known from CA 1172904, WO97/10902 and U.S. Pat. No. 5,368,452. Also, in the pump known from WO2009/024619 a disproportionately large amount of compressed air is required for the operation of the pump. Also, these pumps are not pressure intensified, so that the conveying pressure always lies below the feed pressure.

The object of the invention is to provide a valve for an alternately driven pump, with which the pump can reach a high efficiency.

This object is achieved according to the invention with a valve having the features of claim 1. Advantageous modifications of the valve according to claim 1 are disclosed by the features of the sub-claims.

The underlying concept of he invention is that the valve connects the two valve outlets connectable to the pump working chambers to one another via the valve control element in a central transition region between the end positions of the valve control element.

As already described in the introduction, such pumps as a rule comprise a piston-cylinder system, wherein the piston hermetically separates the two working chambers from one another. Depending on which working chamber is filled with compressed air or a liquid medium, the piston is adjusted to the left or to the right to its respective end positions. The movement reversal of the piston takes place in known valves in that the fluid is discharged, i.e. the pressure is released, from the last filled working chamber, and the compressed air or the pressurised liquid medium is introduced through the valve into the other working chamber.

In the valve according to the invention advantageously the already pressurised air of the last filled working chamber is not discharged unutilised to the surroundings, but is used for the prefilling of the working chamber that is due to be filled next. In this way compressed air is advantageously saved, whereby such as pump can be operated in a more energy-efficient manner.

Advantageously the main valve is designed as a 412-way valve or as a 5/2-way valve. It thus has two valve outlets for the connection of the working chambers of the pump, an inlet for the fluid supplied from an external pressure source, as Well as one or two outlets that serve for the alternate outflow of the fluid under pressure in the working chambers of the pump.

Since the valve control element of the valve moves alternately backwards and forwards only between its two end positions and remains respectively only within these positions, in the context of the present invention it is by definition a valve with two switching positions. The connection of the two valve pump outlets takes piece during passage through the central region between the two end positions. Here the valve control element is not in a defined switching position. If on the other hand the central region should also be understood as a switching position, then the valve according to the invention would advantageously be a 5/3-way or 4/3-way valve.

If for example the pump is a pneumatically driven pump, then during the movement phase of the valve control element and passage through the central region between the end positions, the two working chambers of the piston-cylinder system of the attached pump are connected to one another via the valve control element and thus the receiving working chamber is prefilled with the compressed air from the delivering working chamber. During further travel to the next end position of the valve control element the short circuit of the pump outlets of the valve is lifted, and the working chamber that was prefilled is flied further with the compressed air. The other working chamber is connected via the valve adjustment member to the valve outlet, so that the residual working air can expand and leave the working chamber, for example through sound absorbers. An improved efficiency of the attached pump can be achieved in this way, since less compressed air is required for the operation of the pump.

Advantageously the valve control element can be driven from one end position to the other end position by means of unregulated fluid pressure. On the other hand in most cases it is necessary to use a regulated fluid pressure source in order to fill the working chambers of the pump. The valve according to the invention can have for this purpose an inlet, for example for unregulated compressed air from an external compressed air source, wherein the valve itself can have a pressure regulating device for generating regulated compressed air at a specific pressure. Likewise the valve can have an inlet for regulated air and an inlet for unregulated air.

The valve control element is advantageously moved backwards and forwards by a piston. The valve control element can in this connection be a part of the piston. The valve control element may however obviously also be formed by the piston itself, it is however particularly advantageous if the valve control element is decoupled from the piston in such a way that it is always reliably held, in particular under the action of pressure, with its bearing surface hermetically abutting a bearing surface of the housing. In this connection duct openings of the control ducts are arranged in the bearing surface of the valve control element, and duct openings of the housing ducts are arranged in the bearing surface of the housing. These openings and ducts co-operate appropriately in the individual movement phases. The bearing surfaces should in this connection preferably be formed planar for production technology reasons.

In order to press the bearing surface against the bearing surface of the housing there may be provided either at least one spring element, which is supported on the piston and forcibly presses the valve control element with its bearing surface hermetically against a bearing surface of the housing. It is also possible however that the valve control element with its bearing surface is forcibly pressed hermetically against the bearing surface of the housing by means of a fluid, for example in the form of a piston-cylinder system that is arranged in the piston of the valve.

The valve control element can advantageously lie in a recess of the piston, wherein in particular at least in the movement direction of the piston a positive engagement exists between the piston and the valve control element, so that the valve control element at least in the movement direction of the piston is not displaceable relative thereto.

The space of the recess is in this connection sealed by means of respectively at least one seal with respect to the working chambers of the valve, which are formed by the piston in co operation with the cylinder.

The valve control element itself can advantageously in a simple modification have a cuboid shape, in which one side forms the bearing surface.

In a preferred embodiment the valve control element has at least one, in particular two, recesses in the bearing surface extending in the movement direction of the valve control element, which co-operate with the openings of the housing in such a way that a valve pump outlet, to which the connecting line to a working chamber A or B of the pump is attached, is connected as desired to the valve outlet, so that the fluid that is still present in the working chamber can expand and be discharged into a fluid reservoir or into the surrounding air, and can flow away. During the movement phase, in which the valve connects the two working chambers of the pump to one another, the pump outlet or pump outflow duct is not connected via the valve control element to any of the valve pump outlets, in order to connect the two pump valve outlets during the central movement phase, the valve control element has a further duct, which is separated from the recesses by wails of the valve control element. Advantageously this duct can run between two recesses spaced apart from one another.

The duct openings in the bearing surface formed by the housing are advantageously arranged so that one or two openings spaced apart from one another for the valve outlet duct is/are arranged in the middle between the openings of the ducts that lead to the valve pump outlets. The interspacing of the two openings for the two ducts that lead to the valve pump outlets should be chosen larger than the length of the recesses in the bearing surface of the valve control element, so as to ensure that in the central region through the recess for a specific path section the valve outlet does not correspond to or overlap with an opening of the ducts that lead to the valve pump outlets. Furthermore in each case ducts that serve to supply the fluid under pressure, in particular compressed air, to the working chambers of the pump terminate in the chamber in which the valve control element is arranged. These ducts are connected to the pump inlet, in this connection it is important that an unblocking of the opening of the connecting duct to a valve pump outlet can only take place when the middle movement phase is finished, i.e. the two pump working chambers are no longer connected to one another. The connection of the working chamber of the pump to be emptied takes place at the same time via the recess(es) of the valve control element up to the outflow duct of the valve.

The valve inlet is in this connection connected via connecting ducts to both front-face regions of the space in which the valve control element is moved. In this case the inflow openings of these connecting ducts can be arranged on both front-face regions of the recess forming the space for the valve control element in the piston. The front-face walls of the recess in the piston can in this connection have offsets forming ducts that are joined to the connecting ducts of the valve inlet.

Advantageously the valve according to the invention is controlled by means of additional switching valves that are actuated and switched by the piston of the pump being driven. Thus, in each case a working chamber of the piston-cylinder system of the valve according to the invention is filled with a pressurised fluid, in particular compressed air, via the switching valves until the valve control element has completely reached its other end position, so that the piston of the pump is displaced from its end position in the direction of its other end position. So long as none of the switching valves is actuated, the valve control element is no longer driven. The valve control element is however held in its end position by the fluid flowing into the working chamber to be respectively filled with pressurised fluid, since this fluid presses against the front wall of the valve control element in the direction of the end position to be maintained, in addition it is held in the end positions by the friction of the seals.

The switching valves can advantageously have throttles, so that the air forced out from the respective working chamber is braked by the respective throttle and as a result the movement of the valve control element of the valve is advantageously slowed down, whereby the phase of the pressure compensation between the preloaded and the shortly to be emptied working chamber, and the next working chamber to be filled in turn, becomes as long as possible. At the start of the movement of the pneumatic piston the throttle still does not act so strongly that the valve control element of the main valve is displaced at high velocity from its end position in the direction of the central region, in which the working chambers of the pneumatic cylinder are short-circuited.

The valve according to the invention and its use in a double membrane pump are described in more detail hereinafter with the aid of the following drawings, in which:

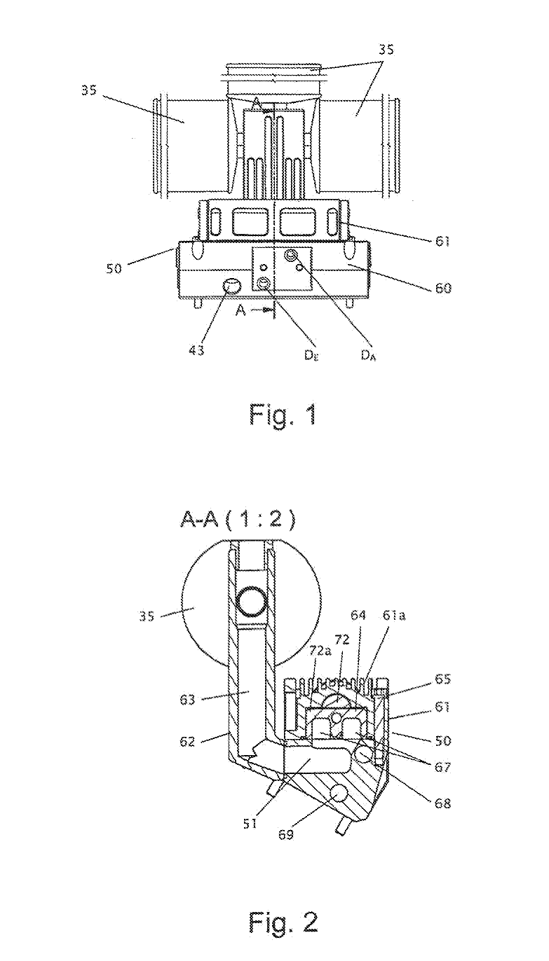

FIG. 1: is a front view of the valve according to the invention with sound absorbers attached thereto;

FIG. 2: is a section through the plane A-A according to FIG. 1;

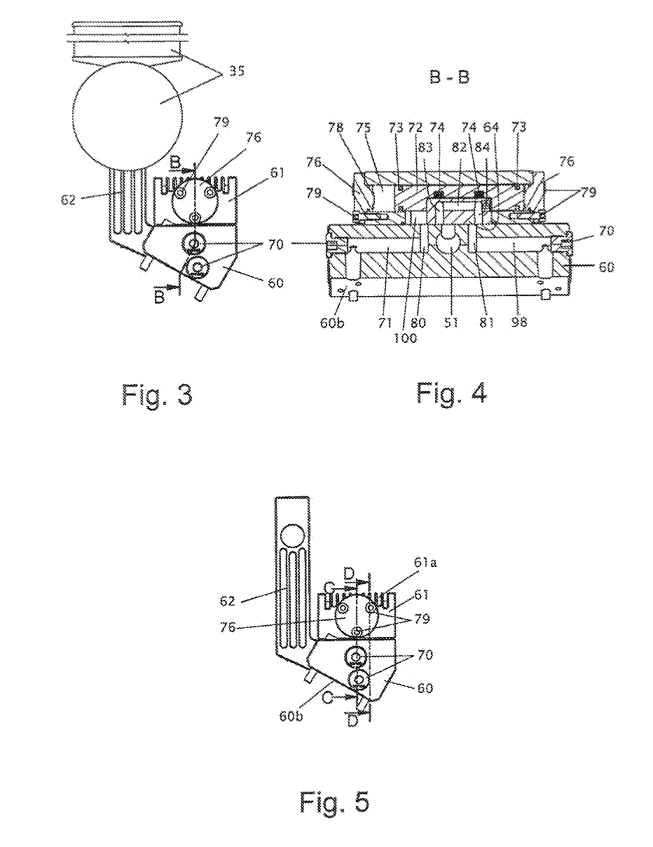

FIG. 3: is a side view of the valve according FIGS. 1 and 2 with sound absorbers attached thereto;

FIG. 4: is a section through the plane B-B according to FIG. 3;

FIG. 5: is a side view of the valve according to FIGS. 1 to 4 without the sound absorbers, in order to show the sectional planes C-C and D-D;

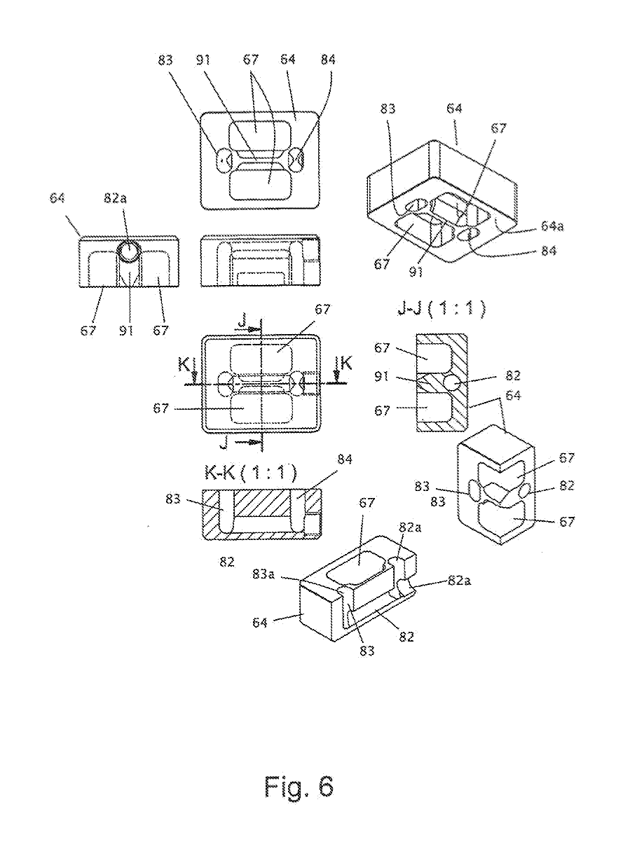

FIG. 6: is a valve control element in various views and sections;

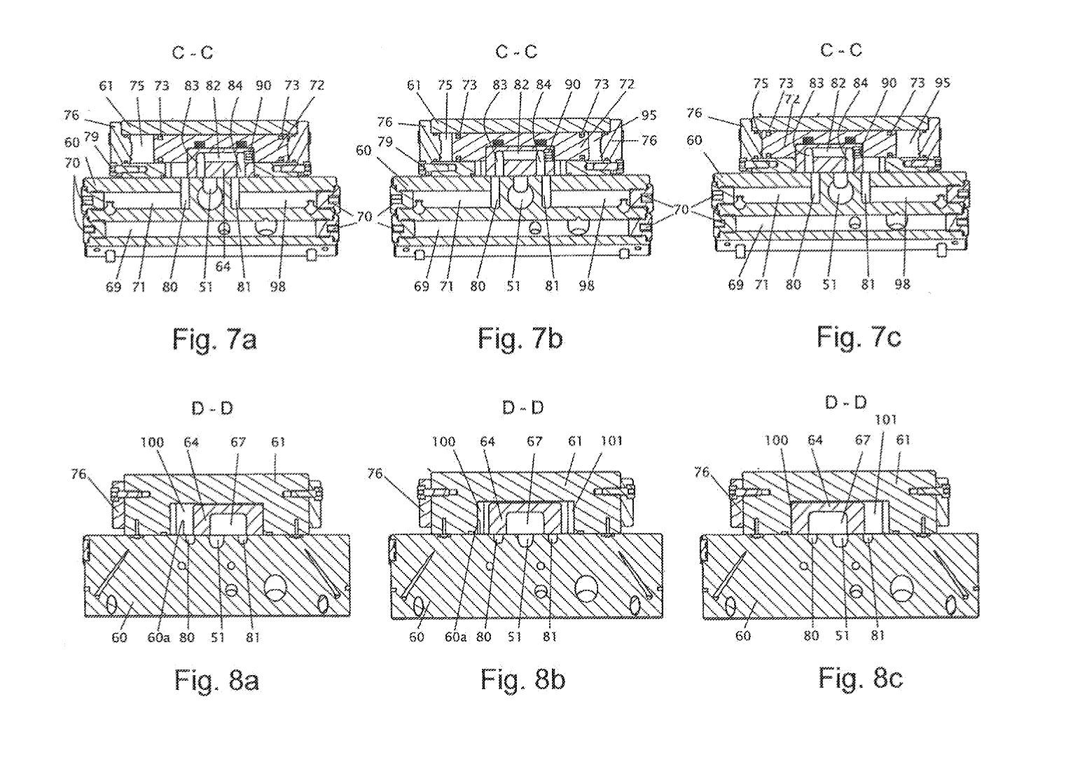

FIG. 7a-c: is a section through the plane C-C according to FIG. 5 with the control element respectively in its two end positions and also in the central region, in which the valve pump outlets are connected to one another by means of the valve control element;

FIG. 8a-c: is a section through the plane D-D according to FIG. 5 with the control element respectively in its two end positions and also in the central region, in which the valve pump outlets are connected to one another by means of the valve control element;

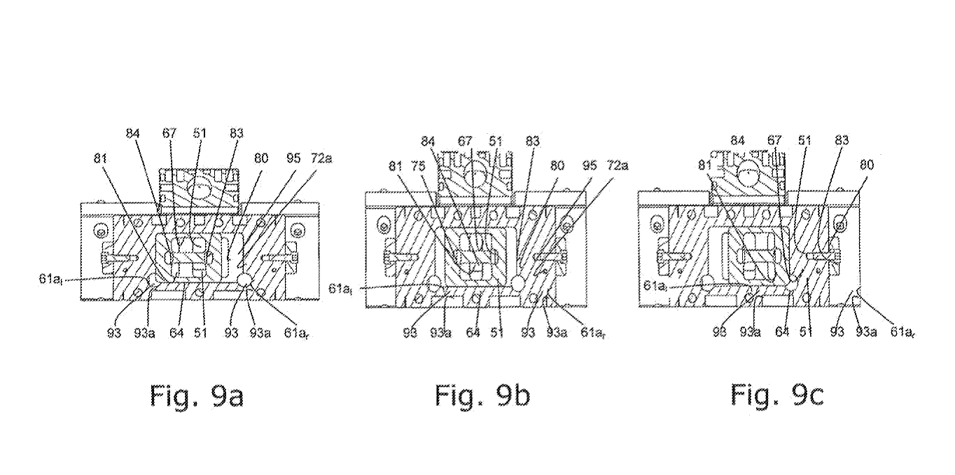

FIG. 9a-c: is a horizontal section through the valve in the region of the valve control element;

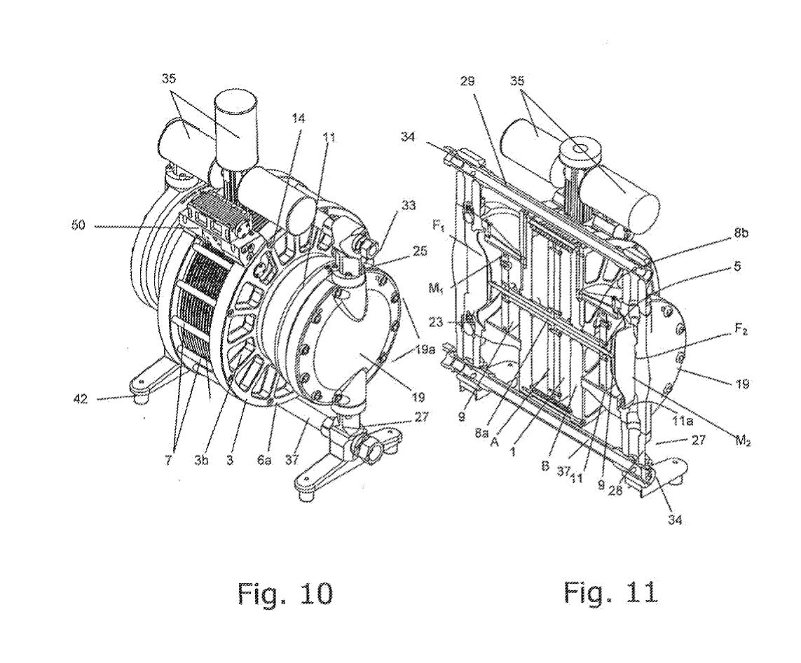

FIG. 10: is a perspective view of the membrane pump according to the invention in the form of a double membrane pump;

FIG. 11: is a sectional view of the membrane pump according to FIG. 10;

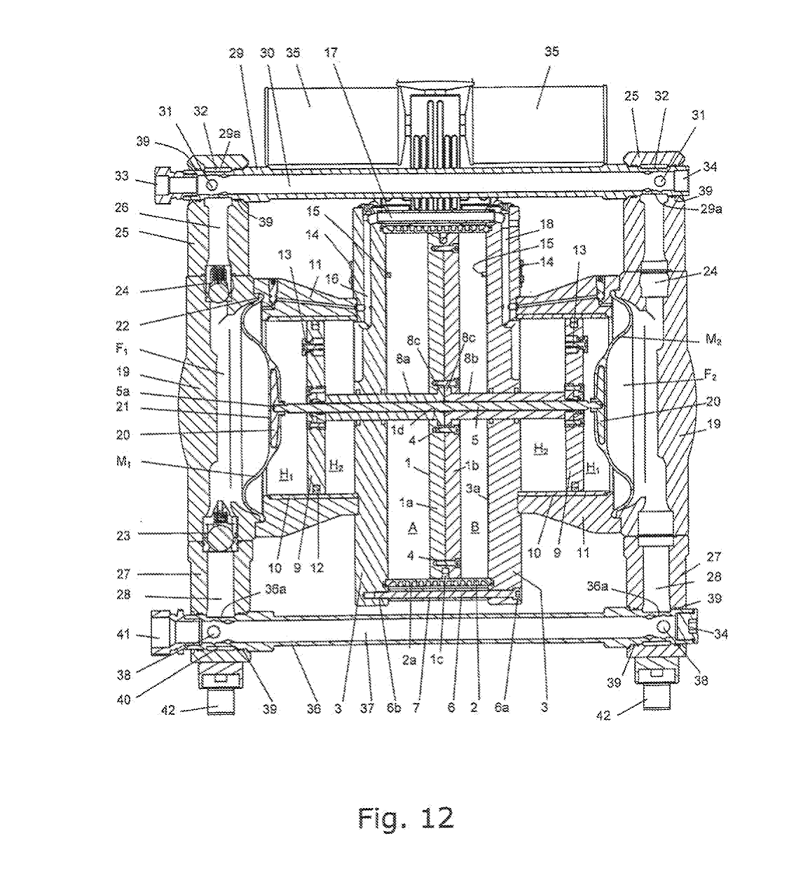

FIG. 12: is a transverse sectional view through the double membrane pump according to FIGS. 10 and 11;

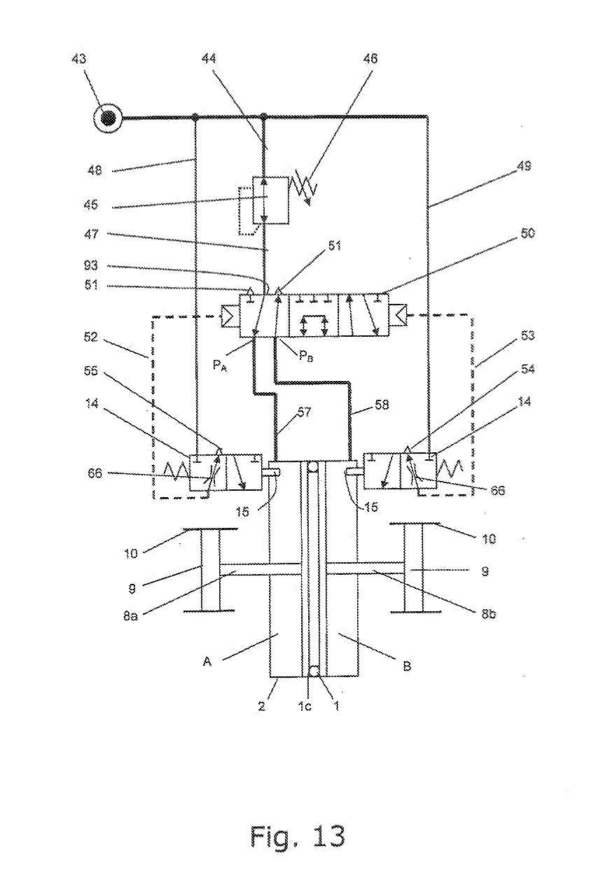

FIG. 13: is a pneumatics arrangement plan for a membrane pump according to the invention with a 5/2-way valve as main valve;

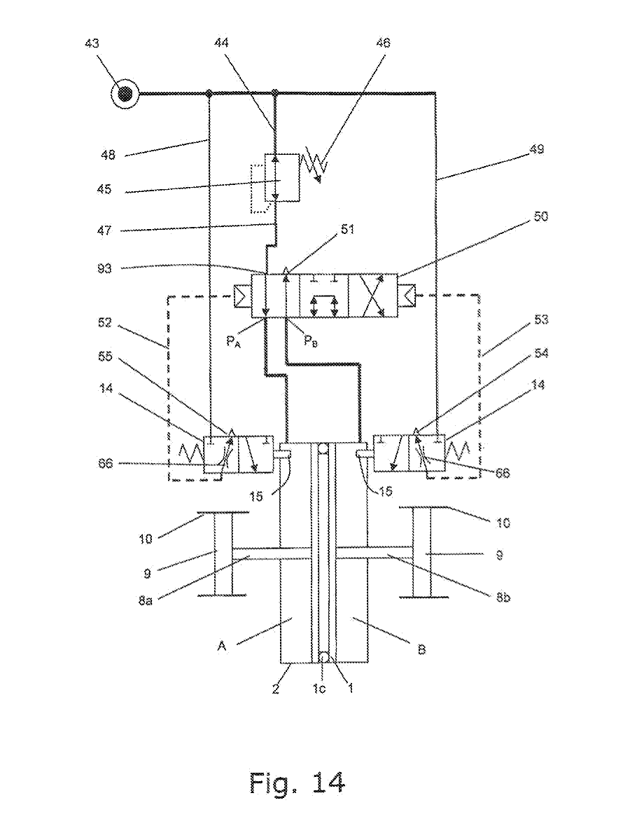

FIG. 14: is a pneumatics arrangement plan for a membrane pump according to the invention with a 4/2-way valve as main valve.

FIG. 1 shows a front view of the valve 50 according to the invention with sound absorbers 35 arranged thereon. The valve 50 comprises a lower housing part 60 and an upper housing part 61. A port 43 is provided in the lower housing part 60, to which a pressure line can be attached for connection to an external pressure generation device (not shown). The valve 50 also has ports D_{E}, D_{A}, to which a pressure regulating device 45, see FIGS. 13 and 14, can be attached with its inlets and outlets. As soon as compressed air from an external compressed air source is connected up to the pump inlet 43, unregulated as well as regulated air at a specific constant pressure thereby becomes available within the housing 60, 61 of the valve 50.

FIG. 2 shows a section through the plane A-A of the valve 50 according to FIG. 1. Ducts 68 and 69 running into the plane of the drawing are arranged in the lower housing part 60. The outflow duct 51 is additionally provided, which can be connected via openings in the bearing surface of the housing part 60 to the recesses 67 in the valve control element 64. The outflow duct 51 is connected to a duct 63 of an adjoining housing part 62, on which are arranged the sound absorbers 35 in order to reduce the sound of the outflowing and expanding compressed air. The valve control element 64 lies in positive engagement in a recess 72a of the piston 72, so that it follows the movements of the piston 72. The housing parts 60 and 61 are connected to one another by means of the connecting screws 65. Cooling ribs 61a are also provided in the upper housing part 61 for better heat absorption.

FIG. 3 shows a side view of the valve 50 according to FIGS. 1 and 2 with sound absorbers 35 arranged thereon. The front faces of the piston-cylinder system of the valve 50 are closed by means of covers 76, the covers 76 being fastened in each case to the housing part 61 by means of three screws 79. The ducts extending longitudinally through the lower valve housing 60 and formed by bores are closed by means of plugs 70.

FIG. 4 shows a section through the plane B-B of the valve illustrated in FIG. 3. The horizontally running ducts 71 and 98 are arranged in the lower housing part 60, and connect the ducts 80 and 81 respectively to the valve pump outlets P_{A} and P_{B}. The further duct configuration can ultimately be adapted as desired to the necessary conditions in each case.

The ducts 80 and 81 terminate in openings 80a, 81a of the bearing surface 60a of the housing part 60, so that they can co-operate with the ducts 83, 84 and the recesses 67 of the valve control element 64. The upper housing part 61 forms together with the front-face housing covers 76 the cylinder for the piston 72, which hermetically seals the two working chambers 75 and 95 from one another by means of seals 73. By means of the seals 73 it is also ensured that no pressure medium can pass from the working chambers 75 and 95 into the recess 72a in which the valve control element 64 is disposed. The valve control element 64 is forced by means of the two springs 74 against the bearing surface 60a of the lower housing part 60, so that with sufficient planarity of both bearing surfaces a satisfactory hermetically is ensured.

FIG. 5 shows a side view of the valve 50 according to FIGS. 1 to 4 in order to illustrate the sectional planes C-C and D-D. The relevant sections are illustrated in FIGS. 7a to 7c and in FIGS. 8a to 8c.

FIG. 5 shows the valve control element 64 in various views and sections. The valve control element 64 comprises a bearing surface 84a, with which it abuts at least over some regions against the bearing surface 60a of the lower housing part 60. The two recesses 67 separated from one another by the web 91 are arranged in the bearing surface 64a. The ducts 83 and 84 extend vertically from the bearing surface 64a into the valve control element 64 and are connected to one another by the duct 83, which is formed by a lateral blind hole bore. The lateral opening 82a is in the assembled state of the valve 50 dosed by a closure screw or plug 90 (see FIG. 7b). The valve control element 64 is of cuboid shape, the edges being formed slightly rounded so that the element is displaceably accommodated in the recess 72a of the piston 72.

FIGS. 7a to 7c show the valve control element 64 in three different positions sectioned through the plane C-C according to FIG. 5. The valve control element 64 is located in FIG. 7a in the right-hand end position and in FIG. 7c in the left-hand end position. FIG. 7b shows the middle position, in which the valve control element 64 connects via the ducts 82, 83 and 84 the two connecting lines 71, 80 and 81, 98 to one another, which lead to the valve pump outlets P_{A}, P_{B}.

FIGS. 8a to 8c show the valve 50 for the same positions of the valve control element 64, but in the sectional plane D-D. In this sectional plane the co-operation of the one recess 67 with the ducts 80, 81 and the outflow duct 51 in the various valve positions can be recognised. In FIG. 8a the duct 81 is connected to the outlet duct 51 via the recess 67. In this end position the recesses 67 as well as the ducts 82, 83, 84 thus form a common connection of enlarged cross section, so that the fluid flowing out and expanding from the working chamber A of the pump can escape outwardly with the maximum possible velocity. The same is also true of the other end position, as illustrated in FIG. 8c, the only difference being here that the valve pump outlet B is connected to the outflow duct 51, in the position of the valve control element 64 illustrated in FIG. 8b the outflow duct 51 is not connected via the recesses 67 to any duct.

FIGS. 9a to 9c show horizontal sections through the valve 50 in the region of the valve control element 64 for the three positions illustrated in FIGS. 7 and 8. in these sectional views the inflow openings 93a can be recognised, through which the fluid under pressure reaches the free chambers 100 and 101 to the left and right of the valve control element 64. As soon as the valve control element 64 unblocks the respective openings of the ducts 80 and 81, the inflowing fluid passes through the connecting ducts 80, 71 and 81, 98 to the valve pump outlets P_{A}, P_{B}. The ducts 93 terminate with their openings 93e in the region of recesses 61aᵣ and 61aₗ of the upper housing part 61.

FIGS. 10 and 11 show a perspective view of a membrane pump in the form of a double membrane pump. The double membrane pump comprises a housing cover 19 and also a housing part 11 accommodating the cylinder 10 of the hydraulically acting piston-cylinder system 9, 10. The housing part 11 is, as illustrated in FIG. 11, fastened by means of coaxial screws 11a to the axial cylinder wall 3 of the first piston-cylinder system. The membrane M is clamped at 22 (see FIG. 12) by the housing cover 19 and the housing part 11. The housing cover 19 and housing part 11 are connected to one another by means of the screws 19a and hold the membrane M in position. The housing cover 19 forms at the bottom and to respectively a seating for a non-return valve 24. The non-valve return valves 23, 24 are inserted into the corresponding recesses of the housing cover 19 before the housing flange 25, 27 is screwed onto the housing cover 19. Additional seals prevent conveying medium from being able to penetrate the housing of the non-return valves 23, 24. The axial walls 3 of the first piston-cylinder system are held spaced apart by means of spacing sleeves 7 and are connected to one another by means of the screws 6. In addition the cylindrical wall sleeve 2, which forms the cylinder, is arranged in a pressure-tight manner between the walls 3, wherein additional seals ensure the hermeticity. The screws 6 have a screw head 6a and at their end a thread 6b, with which they are screwed to the axial wall 3.

The first piston 1, which is formed by two discs 1a, 1b and separates the working chambers A and B from one another, is arranged in the cylinder 2, 3 of the first piston-cylinder system.

The discs 1a, 1b are screwed to one another by means of the screws 4. The cylindrical wall 2 has on its outside surface ribs for absorbing heat from the surrounding air, in order to prevent the membrane pump icing up. The axial walls 3 also comprise recesses 3b, which likewise serve to provide a better thermal conductivity and to stiffen the arrangement and save material. The piston 1 has a surrounding seal 1c, which hermetically abuts against the inner wall of the cylinder 2.

When assembling the piston 1 the piston rods 8a, 8b are inserted beforehand through the bores id until the collars 8c lie in the corresponding recesses to of the piston discs 1a, 1b. As a result of the assembly of the piston discs 1a, 1b, the piston rods 8a, 8b are fixed by positive engagement to the piston 1.

The piston rods 8a, 8b pass through the bores 3a of the axial walls 3, wherein seals 56 ensure that no compressed air can pass from the working chambers A, B into the hydraulic spaces H₂. The piston rods 8a, 8b are hermetically connected at their ends rid to the hydraulic pistons by means of screws 60. The piston rods 8a, 8b are formed as tubes, in which the connecting element 5 is displaceably accommodated in the form of a rod. The connecting element 5 is screwed with its ends 5a provided with an outer thread, into the membrane disc 20. The membrane disc 20 is formed in the membrane M₁ in its centre 21.

The hydraulic pistons 9 likewise comprise a surrounding seal 12, which hermetically abuts against the inner wall of the cylinder war 10 and separates the two working chambers H₁, H₂ from one another. The two hydraulic chambers H₂ of the two hydraulic piston-cylinder systems are connected to one another via the connecting ducts 16, 17 and 18. Differential pressure valves 13 are in each case arranged in the hydraulic pistons 9. As long as the differential pressure between the working chambers H₁ and H₂ exceeds a certain value during the operation of the pump, the differential pressure valve 13 opens and the differential pressure can be reduced to a predetermined value. The connecting duct 16, 17, 18 can be connected by means of a further connecting line (not shown) to a reservoir and/or a sensor, if an inflow or outflow of hydraulic medium now occurs at the reservoir or the connecting line, this may indicate a fracture of the membrane, whereupon an error signal can be sent to an override control and/or the membrane pump is automatically switched off. This can take place for example by the forced closure of the line supplying the pump with compressed air.

The feed ducts 28 are connected to one another by means of the feed line 36, wherein the feed tine 36 forms with its one end 41 the conveying medium inlet of the pump. The other end of the feed line 36 formed as a tube is closed by means of a screwed-in plug 34. The feed line 36 lies with its regions 36a in a floating manner in the housing flanges 27, wherein seals 39 provide the necessary hermeticity. The housing flanges 27 comprise an annular space 40 enclosing the regions 38a, which is formed by a surrounding groove. In the region 36a the feed fine 36 has window-like openings 38, through which the conveying medium passes from the interior 37 of the feed fine 36 into the annular space 40 and from there into the feed duct 28.

The outflow ducts 26 are connected to one another by means of the pressure line 29, wherein the pressure line 29 forms with its one end 33 the conveying medium outlet of the pump. The other end of the pressure line 29 formed as a tube is dosed by means of a screwed-in plug 34. The pressure fine 29 lies with its regions 29a in a floating manner in the housing flanges 25, wherein seals 39 provide the necessary hermeticity. The housing flanges 25 have an annular space 32 enclosing the regions 29a, which is formed by a surrounding groove. in the regions 29a the pressure line 29 comprises window-like openings 31, through which the conveying medium can pass from the annular space 32 into the interior 30 of the pressure line 29.

Switching valves 14, which reach via an extension 15 of their valve control members into the working chambers A, B, are arranged in the axial wails 3. As soon as the piston 1 reaches its dead centre, the respective switching valve is actuated, whereby compressed air is fed to the main valve 50 via ducts (not shown), and the main valve is in turn switched.

The main valve 50 according to the invention is arranged externally on the pump housing, so that a good heat exchange with the ambient air can take place, whereby the danger of icing up is reduced.

As soon as the membrane disc 20 is adjusted by means of the hydraulic piston 9 so that the volume of the conveying chamber F₁ is reduced, the conveying medium present in the conveying chamber F₁ is conveyed through the non-return valve 24 to the outflow duct 26. The non-return valve 23 is closed during this operation. If the volume of the conveying chamber F₁ is then increased by retracting the membrane M₁, conveying medium is suctioned from the feed line 36 into the conveying chamber F₁ through the now opened non-return valve 23. The non-return valve 24 is closed during the suction phase.

FIG. 13 shows a pneumatic arrangement plan of the membrane pump according to FIGS. 10 to 12. The membrane pump operated with compressed air has a compressed air inlet 43, which is advantageously arranged on the valve 50 according to the invention. The pressure regulating device 45 can be arranged in or on the main valve 50, and is connected by means of the connecting line 44 to the inlet 43. The pressure regulating device 45 can be a proportional valve, which can have an adjustment mechanism, for example in the form of an adjustment screw, with which a spring can be pretensioned for the pressure adjustment. If an unregulated pressure of 7 bar is made available through the external compressed air source (not shown), then a regulated compressed air of e.g. 5.5 bar can be supplied by the pressure regulating device 45 via the connecting line to the main valve 50.

The inlet 43 is connected via connecting lines 48, 49 to the switching valves 14. The switching valves are formed as 3/2-way valves and are switched by means of the extensions 15 of their valve control members extending into the working chambers A, B. A spring forces the valve control members into the illustrated position, in which the control lines 52, 53 are not connected to the valve inlet or to the connecting line 48, 49. As soon as the piston 1 adjusts the respective valve control member 15, the switching valve 14 is switched and the unregulated compressed air from the external compressed air source switches the valve 50 according to the invention.

The valve 50 is formed as a 5/2-way valve. In the illustrated position the regulated compressed air reaches the working chamber A via the connecting line 57. The piston 1 is thus displaced to the right together with the hydraulic piston 9. Due to the hydraulic medium present in the hydraulic chambers H₁ the right-hand membrane (not shown) is now displaced to the right, whereby its associated conveying chamber is reduced in size. The right-hand membrane is thus in conveying mode, and at the same time the left-hand membrane, likewise not illustrated in FIG. 5, suctions conveying medium from the feed line into its conveying chamber. When the right-hand dead centre is reached the right-hand switching valve is switched via the extension 15, so that the main valve 50 is likewise switched. In the leftwards movement first of ell the connection of the working chamber A to the connecting line 47 is interrupted. Following this the two working chambers are short-circuited with one another, so that the pressurised compressed air in the working chamber B can expand into the working chamber A. A certain amount of time is available for this, until finally the main valve 50 has completely switched over and regulated compressed air is fed into the working chamber B via the connecting line 47, whereupon the piston 1 is now moved to the left. The remaining still unreleased compressed air in the working chamber B then expands via the valve outlets 51 through the sound absorbers 35 to the surroundings.

FIG. 14 shows an alternative embodiment, in which the valve 50 according to the invention is formed as a 4/2-way valve. The valve 50 differs from the valve illustrated in FIG. 13 simply in that only one outlet 51 is provided.

### LIST OF REFERENCE NUMERALS

A, B Working chamber of the first piston-cylinder system
M₁, M₂ Membrane
1 First piston of the first piston-cylinder system
1a, 1b Piston discs
1c Seal
1d Bore
1e Recess for collar 8c
2 Cylinder of the first piston-cylinder system
2a External cooling ribs of the cylinder 2
3 Axial cylinder wall of the first piston-cylinder system
4 Screws
5 Connecting element
5a Thread of the connecting element 5
6 Connecting screw
7 Spacing sleeve
8a, 8b Piston rod
8c Collar
9 Hydraulic piston
10 Cylinder of the hydraulically acting piston-cylinder system
11 Housing part
12 Seal
13 Differential pressure valve (p_{H1}>p_{H2})
14 Switching valve
15 Valve control member
16, 17, 18 Duct/connecting line
19 Housing cover
20 Membrane disc
21 Membrane region in which the membrane disc 20 is arranged
22 Clamping region of the membrane M₁
23 Non-return valve in the feed duct (shown only in the left-hand chamber)
24 Non-return valve in the outflow duct (shown only in the left-hand chamber)
25 Housing flange with outflow duct 26 (outflow housing)
26 Outflow duct
27 Housing flange with feed duct 28 (inflow housing)
28 Feed duct
29 Pressure line
30 Interior of the pressure line 29
31 Through opening in wall of the pressure line 29
32 Annular space surrounding the pressure line 29
33 Pump outlet for conveying medium
34 Plug with screw thread
35 Sound absorber for outflow of the expanding compressed air
36 Feed line
37 Interior of the feed line 36
38 Through opening in wail of the feed line 36
39 Sealing rings
40 Annular space surrounding the feed line 36
41 Pump inlet for conveying medium
42 Foot
43 Inlet for unregulated compressed air from an external compressed air source
44 Connecting line
45 Pressure regulating device in the form of a proportional valve
46 Adjustment mechanism for regulated outlet pressure of the pressure regulating device 46
47 Connecting line feeding regulated compressed air to the main valve 50
48, 49 Connecting line for unregulated compressed air
50 Main valve
51 Outlets of the main valve, which are connected to the sound absorbers 35
52, 53 Control line from the switching valve 14 to the main valve 50
54, 55 Outlet to the surroundings
56 Seal
57 Connecting line to the working chamber A
58 Connecting line to the working chamber B
58 Lower valve housing part
60a Housing-side bearing surface for valve control element 64
61 Upper valve housing part
61aₗ, 61aᵣ Recesses of the upper housing part 61
62 Housing part carrying the sound absorbers 35 with inner duct 63
63 Inner duct
64 Valve control element
64a Bearing surface of the valve control element 64
65 Connecting screw
66 Throttle
67 Recess in the bearing surface 64a of the valve control element 64
68 Duct
69 Duct
70 Closure plugs
71 Connecting duct to the valve pump outlet A
72 Piston
72a Recess in the piston for valve control element 64
73 Sealing ring
74 Spring element
75 Left-hand working chamber
76 Front-face housing cover
78 Seal
79 Fastening screws
80 Connecting duct
80a Duct opening of the connecting duct 80 in the bearing surface of the housing
81 Connecting duct
81a Duct opening of the connecting duct 80 in the bearing surface of the housing
82, 83, 84 Connecting duct in the valve control element 64 for the connection of the valve pump outlets P_{A} and P_{B}
90 Closure screw for bore forming the duct 63
93 Connecting duct to the valve inlet
93a Opening of the connecting duct 93 in the bearing surface 60a
95 Right-hand working chamber
98 Connecting duct to the valve pump outlet 8
100, 101 Free space, to the left and right of the valve control element 64 through which fluid flows along the respective connecting ducts to the valve pump outlets P_{A} and P_{B}

1. A valve for alternately filling two working chambers of a piston-cylinder system of a pump with a fluid, wherein the pump has two valve pump outlets for connection to the working chambers of the pump, the valve including:
a valve control element which is displaceably arranged in a chamber of a valve housing and is driven backwards and forwards between two end positions by means of a fluid, wherein the valve control element comprises control ducts configured to co-operate with housing ducts arranged in the valve housing, wherein the first valve pump outlet is connected to the housing ducts and the second valve pump outlet is connected to the housing ducts
wherein in a central region between the two end positions the valve pump outlets are connected to one another via control ducts of the valve control element.

2. The valve according to claim 1, wherein a piston dividing a space into two working chambers hermetically sealed from one another forms and/or moves the valve control element.

3. The valve according to claim 2, wherein the valve control element is forced under pressure with a bearing surface of the valve control element hermetically against a bearing surface of the housing, wherein duct openings of the control ducts are arranged in the bearing surface of the valve control element and duct openings of the housing ducts are arranged in the bearing surface of the valve housing.

4. The valve according to claim 3, wherein at least one spring element is supported on the piston and is arranged to forcibly press the valve control element with its bearing surface hermetically against a bearing surface of the housing, or wherein a fluid is arranged to forcibly press the valve control element with its bearing surface hermetically against a bearing surface of the housing.

5. The valve according to claim 1, wherein the valve control element lies in a recess of the piston, wherein a positive engagement exists between the piston and the valve control element at least in the movement direction of the piston.

6. The valve according to claim 5, wherein the space of the recess is hermetically sealed with respect to the working chambers by means of, in each case, at least one seal.

7. The valve according to claim 1, wherein bearing surfaces of the valve control element and of the housing are formed in a planar fashion.

8. The valve according to claim 1, wherein the valve is formed as a 5/2-way valve or a 4/2-way valve, wherein the housing has, in a space, a duct opening of an outflow duct, a duct opening of a connecting duct to a valve pump outlet, a duct opening of a connecting duct to a valve pump outlet, and also two duct openings of a connecting duct to a valve inlet.

9. The valve according to claim 8, wherein the valve control element comprises at least one recess in the bearing surface of the valve control element extending in a movement direction of the valve control element, wherein the at least one recess is configured to cooperate with openings of the housing, and
wherein a further connecting duct is arranged in the valve control element and is configured to connect the connecting ducts to one another in a central region in which the valve control element is located between the end positions, wherein in this central region the outflow duct is not connected via the at least one recess to one of the connecting ducts.

10. The valve according to claim 9, wherein in movement phases that lie between the end positions and the central region, in each case one of the two connecting ducts is connected via the at least one recess to the outflow duct, wherein at the same time the other one of the two connecting ducts is connected by space released by the valve control element to a connecting duct to the valve inlet.

11. The valve according to claim 10, wherein the connecting duct to the valve inlet has on both front-face regions of the space an inflow opening.

12. The valve according to claim 1, further comprising a pressure regulating device arranged in or on the valve, and a valve inlet for a fluid, wherein the fluid is supplied to the pressure regulating device via a duct, and wherein an outlet of the pressure regulating device is connected via a connecting line to a connecting duct.

13. The valve according to claim 12, wherein at least one connecting duct is arranged in the housing of the valve and is adapted to connect the valve inlet to an inlet of the pressure regulating device.

14. The valve according to claim 1, wherein the fluid adjusting the piston of the piston-cylinder system has a higher pressure than fluid that reaches a space released by the valve control element via the duct openings.

15. The valve according to claim 1, wherein exclusively a fluid forcibly acts on and drives the valve control element or the piston of the piston-cylinder system in such a way that the valve control element or the piston moves alternately backwards and forwards between its end positions.

16. The valve according to claim 1, wherein the valve is a 4/2-way valve or a 5/2-way valve, wherein in the end positions and in a central region, the two valve pump outlets are connected to one another via the valve control element.

17. A valve arrangement including:
the valve according to claim 1, configured for alternately filling two working chambers of the piston-cylinder system of a pump with a fluid, and switching valves configured to be actuated by the pump and configured to switch the valve.

18. The valve arrangement according to claim 17, further comprising throttles arranged in the switching valves and configured to brake or slow down movement of the valve control element at least during a middle movement phase.

19. The valve according to claim 11, wherein the connecting duct of the valve inlet is connected at least over certain regions to front-face recesses of the piston.

20. The valve according to claim 12, wherein the pressure regulating device comprises a proportional valve and the fluid comprises compressed air.
